(19) United States
(12) Patent Application Publication
(10) Pub. No.: US 2026/0152134 A1
(43) Pub. Date: Jun. 4, 2026

(54) ATTACHING DEVICE FOR ATTACHING PROTECTION MEMBER IN VEHICLE

(71) Applicant: TOYOTA JIDOSHA KABUSHIKI KAISHA, Toyota-shi (JP)

(72) Inventor: Tomoki SAKATA, Toyota-shi (JP)

(73) Assignee: TOYOTA JIDOSHA KABUSHIKI KAISHA, Toyota-shi (JP)

(21) Appl. No.: 19/398,174

(22) Filed: Nov. 24, 2025

(30) Foreign Application Priority Data
Dec. 2, 2024 (JP) 2024-209771

(51) Int. Cl. B60R 16/023

(52) U.S. Cl. CPC B60R 16/0239

(57) ABSTRACT

An attaching device for attaching a protection member that is to be disposed to cover a service hole of a casing housing at least one of an electric-power control device and an electric motor of a vehicle. The attaching device includes: (a) a bolt configured to attach the protection member to the casing; and (b) a locking unit configured to lock the bolt, by being introduced in a lock hole of the protection member. The locking unit is located in a position relative to the bolt such that at least a part of the locking unit interferes with a holding/turning tool that is to be used for holding and turning the bolt.

### FIELD OF THE INVENTION

This application claims priority from Japanese Patent Application No. 2024-209771 filed on Dec. 2, 2024, the disclosure of which is herein incorporated by reference in its entirety.

The present invention relates to an attaching device for attaching a protection member in a vehicle, so as to cover high-voltage components of the vehicle for avoiding the high-voltage components from being exposed, such that the attached protection member cannot be removed by an operation using an ordinary tool.

### BACKGROUND OF THE INVENTION

For example, in a vehicle that use an electric motor as a drive source, such as hybrid electric vehicle (HEV) and battery electric vehicle (BEV), there are used high-voltage components such as bus bars to supply an electric power from an inverter to the electric motor. The high-voltage components are housed in a casing that houses an electric-power control device (PCU) and/or the electric motor. A service hole is provided in the casing to allow access by operators. A service cover as a high-voltage protection member is attached to cover the service hole so as to avoid the high-voltage components from being exposed, for thereby protecting the operators from the high-voltage components of the vehicle. For example, a housing of the electric-power control device is disclosed in Patent Document 1.

In Patent Document 1, the housing that houses an inverter is fixed onto a transaxle casing that houses an electric motor, and a service hole formed on a side surface of the housing is covered with a service cover, which is fixed with an ordinary bolt.

### PRIOR ART DOCUMENT

### Patent Document

[Patent Document 1]

Japanese Patent Application Laid-Open 2023-93014

### SUMMARY OF THE INVENTION

By the way, in Patent Document 1, a service plug is provided to protrude from a back surface of the service cover, and, when a distal end portion of the service plug is inserted into a plug receiving portion of the housing, an electric power is allowed to flow through the electric-power control device (PCU), but, when the service cover is removed and the distal end portion of the service plug is pulled out from the plug receiving portion, the electric power is inhibited from flowing through the electric-power control device, thereby protecting the operators from high voltage.

The back surface of such a service cover has the service plug and a plurality of protruding plate-shaped ribs. When the service cover is to be attached, the plate-shaped ribs come into contact with upper and lower inner walls of the service hole so as to position the service cover. This allows the service plug to be guided by the plate-shaped ribs, making it easy to insert the service plug into the plug receiving portion.

However, since the service cover is fixed to the side surface of the housing with the ordinary bolt, the service cover can be removed using an ordinary tool. This means that there is a risk that an installation state of the high-voltage components could be changed if the service cover is removed by someone other than a dealer or other authorized operators.

The present invention was made under background of the above circumstances, and a purpose of the invention is to provide an attaching device for attaching a protection member in a vehicle, wherein the attaching device has a simple structure that makes it impossible to remove the service cover by using an ordinary tool. Another purpose of the invention is to provide a combination including the protection member and the attaching device.

According to a first aspect of the invention, there is provided an attaching device for attaching a protection member that is to be disposed to cover a service hole of a casing housing at least one of an electric-power control device and an electric motor of a vehicle. The attaching device includes: (a) a bolt configured to attach the protection member to the casing; and (b) a locking unit configured to lock the bolt, by being introduced in a lock hole of the protection member. The locking unit is located in a position relative to the bolt such that at least a part of the locking unit interferes with a holding/turning tool that is to be used for holding and turning the bolt.

In the attaching device according to the first aspect of the invention, the holding/turning tool that attempts to hold and turn the bolt interferes with the locking unit, which is fixed in the lock hole of the protection member such that the locking unit cannot be rotated about an axis by a predetermined angle or more, whereby an operation for removing the bolt by the holding/turning tool is inhibited, namely, the protection member cannot be removed by using the ordinary holding/turning tool. Further, protection from high-voltage components can be achieved by using a simple structure in which the locking unit is fixed to the protection member.

According to a second aspect of the invention, in the attaching device according to the first aspect of the invention, the locking unit includes: (b-1) a main body including: a cup-shaped cylindrical portion; an outwardly protruding portion that protrudes outwardly from the cup-shaped cylindrical portion; and a plurality of insert portions each of which has an inwardly protruding portion and protrudes outwardly from an opening end of a center hole of a bottom wall of the cup-shaped cylindrical portion in an axial direction of the center hole; and (b-2) an operation member including: a disc-shaped portion that is to be engaged in an inner circumferential surface of the cup-shaped cylindrical portion; and a shaft portion that extends from a center of the disc-shaped portion and passes through the center hole of the bottom wall of the cup-shaped cylindrical portion so as to protrude from the opening end of the center hole further than the inwardly protruding portion of each of the insert portions. The shaft portion has a first tapered portion, a second tapered portion and an annular groove portion that is provided between the first and second tapered portions in an axial direction of the shaft portion, such that the inwardly protruding portion of each of the insert portions is to be engaged in the annular groove portion of the shaft portion. The operation member has an operation-member-side cam protrusion provided in the disc-shaped portion, while the main body has a main-body-side cam protrusion provided in the bottom wall, such that the operation-member-side cam protrusion and the main-body-side cam protrusion are opposed to each other, so as to come into contact with each other. Thus, when the operation member is pushed into the main body and placed in the lock position, with the operation member being inserted in the lock hole, the disc-shaped portion of the operation member is received in the cup-shaped cylindrical portion of the main body, and at the same time, the second tapered portion causes a diameter defined by the plurality of insert portions to be expanded within the lock hole, thereby fixing the locking unit to the lock hole. However, when the operation member is rotated around the axis of the cup-shaped cylindrical portion by using a special tool, the operation-member-side cam protrusion and the main-body-side cam protrusion come into sliding contact with each other, and when the operation member is returned from the lock position, the inwardly protruding portion of each of the insert portions is returned into the annular-groove portion and the diameter defined by the plurality of insert portions is reduced, so that the locking unit is allowed to be removed from the lock hole.

According to a third aspect of the invention, there is provided a combination including a protection member that is to be disposed to cover a service hole of a casing housing at least one of an electric-power control device and an electric motor of a vehicle; and the attaching device according to the second aspect of the invention. A lock hole of the protection member, in which the locking unit is introduced to lock the bolt, is located in a position relative to the bolt such that at least one of the cup-shaped cylindrical portion and the outwardly protruding portion of the main body of the locking unit interferes with a holding/turning tool that is to be used for holding and turning the bolt. Thus, the protection member cannot be removed by using the ordinary holding/turning tool.

According to a fourth aspect of the invention, there is provided a combination including a protection member that is to be disposed to cover a service hole of a casing housing at least one of an electric-power control device and an electric motor of a vehicle; and the attaching device according to the second aspect of the invention. The protection member includes an engaging portion that is engaged with the outwardly protruding portion of the main body of the locking unit. Thus, even if the locking unit fixed in the lock hole is attempted to be rotated around the axis of the main body, the engaging portion of the protection member interferes with the outwardly protruding portion of the main body of the locking unit, thereby preventing the locking unit from being rotated around the axis.

According to a fifth aspect of the invention, in the combination according to the fourth aspect of the invention, the engaging portion of the protection member is provided in an inclined plate portion of the protection member, and the inclined plate portion of the protection member and the casing cooperate with each other to define a gap therebetween. Thus, it is possible to eliminate a need to form holes through the casing for inserting the plurality of insert portions and the shaft portion of the locking unit, thereby eliminating restrictions on installation locations, and allowing a size of the casing to be smaller than where the holes are formed through the casing.

### BRIEF DESCRIPTION OF THE DRAWINGS

FIG. 1 is a view showing main parts of an electromechanical integrated unit of an electric vehicle to which an attaching device of the present invention is applied, and showing a state in which a service cover is removed;

FIG. 2 is a view showing an example of an electrical configuration related to a control for driving the electric vehicle shown in FIG. 1;

FIG. 3 is a perspective view showing the service cover attached to the electromechanical integrated unit shown in FIG. 1;

FIGS. 4A and 4B are cross-sectional views showing a lock striker shown in FIG. 3, wherein FIG. 4A shows an unlocked state and FIG. 4B shows a locked state;

FIG. 5 is a perspective view showing a special tool integrated with a service plug; and

FIGS. 6A and 6B are views for explaining an effect of preventing removal with an ordinary tool in the attaching device of the present invention, wherein FIG. 6A shows a case in which the ordinary tool is a box wrench, and (b) shows a case in which the ordinary tool is a standard wrench.

### DETAILED DESCRIPTION OF PREFERRED EMBODIMENT

Hereinafter, an embodiment of the present invention will be described in detail with reference to the drawings.

### Embodiment

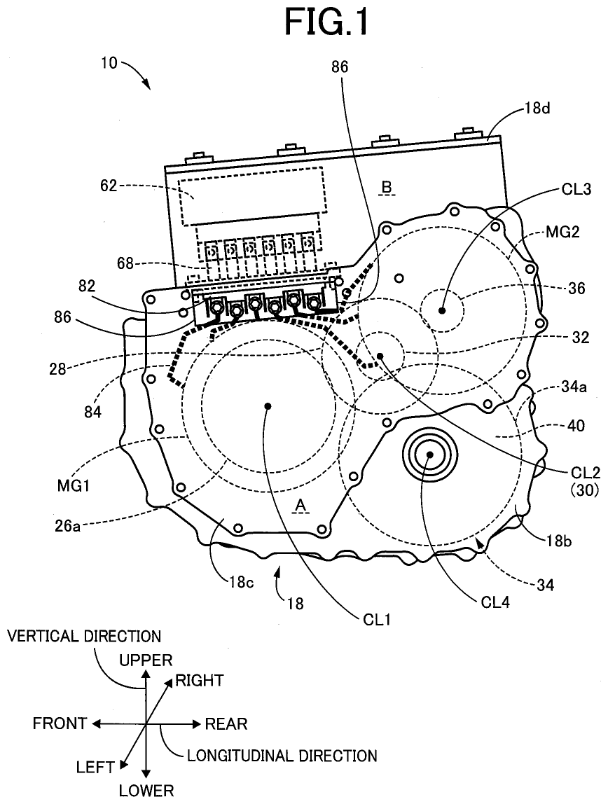

FIG. 1 shows an example of a drive unit 10 for an electric vehicle. A casing 18 of the drive unit 10 includes a casing body 18b with openings on the left, right, and top, a cover 18c that closes the left opening of the casing body 18b, a protection plate 18d that closes the top opening of the casing body 18b, and a cylindrical housing that houses a differential mechanism (not shown). The right opening of the casing body 18b is connected to the housing (not shown), and the housing is further connected to an engine (not shown). The power split mechanism, housing and engine are hidden by the casing 18 in FIG. 1 and are not shown in FIG. 1. A first axis CL1 sown in FIG. 1 coincides with rotational axes of a sun gear of the power split mechanism, a crankshaft of the engine and a first electric motor MG1.

The casing body 18b has a partition wall (not shown) therein, which divides an inner space of the casing body 18b into two space sections that are a lower space section A and an upper space section B. The lower space section A is a lower section of the inner space of the casing body 18b in a vertical direction. The upper space section B is an upper section of the inner space of the casing body 18b in the vertical direction. In the lower space section A, there are stored the first electric motor MG1 that is connected to the engine via the power split mechanism, a second electric motor MG2 that is to be rotated about a third axis CL3 parallel to the first axis CL1, a counter driven gear 28 that meshes with a ring gear 26a of the power split mechanism and an output gear 36 of the second electric motor MG2, a counter shaft 30 that is to be rotated about a second axis CL2 parallel to the first axis CL1, a ring gear 34a that meshes with a counter drive gear 32 of the counter shaft 30, and a differential gear mechanism 40 that is to rotated about a fourth axis CL4 parallel to the first axis CL1. The differential gear mechanism 40 is configured to transmit a power to a pair of left and right drive wheels such as front wheels or rear wheels, through a pair of left and right drive shafts (not shown).

In the upper space section B, there are stored an inverter 62 and other components. A high-voltage power is supplied from the inverter 62 to the first electric motor MG1 and the second electric motor MG2 via busbars 68, a terminal block 82 and MG busbars 84. An elongated service hole 86 is formed through a side surface of the casing body 18b to enable an operator to perform maintenance on the busbars 68, the elongated terminal block 82 and the MG busbars 84 from the outside. The service hole 86 exposes high-voltage components such as the terminal block 82, the busbars 68 connected to the terminal block 82, and the MG busbars 84.

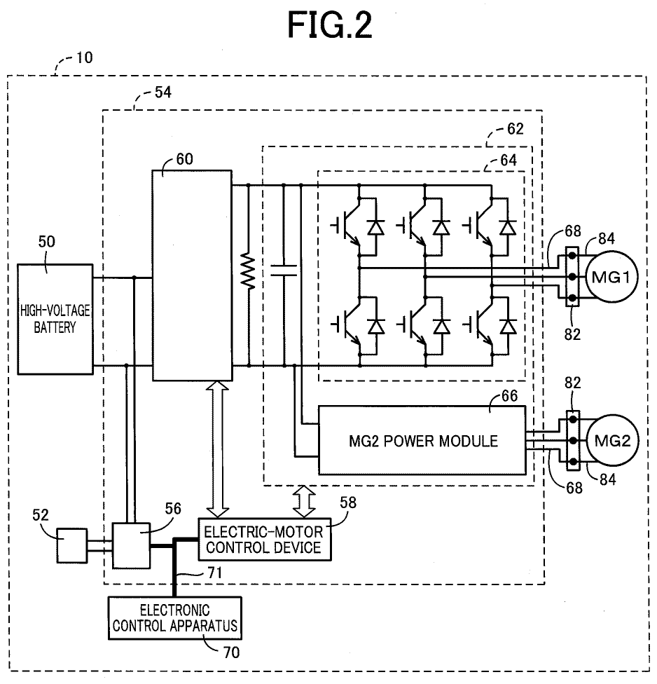

FIG. 2 is a view showing an example of an electrical configuration related to controls of the first electric motor MG1 and the second electric motor MG2. The electric vehicle further includes a high-voltage battery 50, an auxiliary-equipment battery 52 and an electric-power control unit 54, which are related to the controls of the first electric motor MG1 and the second electric motor MG2.

The high-voltage battery 50 is a rechargeable secondary battery such as a nickel-metal hydride battery or a lithium-ion battery. The high-voltage battery 50 is connected to the electric-power control unit 54. A stored electric power is supplied from the high-voltage battery 50 to, for example, the second electric motor MG2 via the electric-power control unit 54. In addition, the electric power generated by the power generation control of the first electric motor MG1 and the electric power generated by the regeneration control of the second electric motor MG2 are also supplied to the high-voltage battery 50 via the electric-power control unit 54. The high-voltage battery 50 is equipped with a connector (not shown) to which a service plug SP (described below) is connected. When the service plug SP is removed, the electric-power control unit 54 is disconnected from the high voltage.

The electric-power control unit 54 includes a DC-DC converter 56, an electric-motor control device 58, a boost converter 60 and the inverter 62. The electric-power control unit 54 is an electric-power control device that controls the electric power exchanged between the high-voltage battery 50 and the electric motor MG. In other words, the electric-power control unit 54 is an electric-power control device that controls the first electric motor MG1 and the second electric motor MG2.

The DC-DC converter 56 is connected between the high-voltage battery 50 and the inverter 62. The DC-DC converter 56 functions as a charging device that reduces the voltage of the high-voltage battery 50 (for example, several tens of volts) to a voltage equivalent to that of the auxiliary-equipment battery 52 (for example, 12 volts) and charges the auxiliary-equipment battery 52. The auxiliary-equipment battery 52 supplies the electric power to operate auxiliary equipment provided in the electric vehicle, the electric-motor control device 58 and an electronic control apparatus 70 (described later), for example.

The boost converter 60 is equipped with a reactor and switching elements (not shown). The boost converter 60 is a circuit that has functions of boosting the voltage of the high-voltage battery 50 to a higher voltage (several hundred volts) and supplying it to the inverter 62, and of stepping down the voltage converted to direct current by the inverter 62 and supplying it to the high-voltage battery 50. The inverter 62, first electric motor MG1 and second electric motor MG2 are components that are operated at high voltage.

The inverter 62 is equipped with an MG1 power module 64, an MG2 power module 66, for example. Each of the MG1 power module 64 and the MG2 power module 66 includes a plurality of transistors that convert direct current into alternating current by being turned on and off as switching elements. The electric vehicle is equipped with the busbars 68 and the MG busbars 84 as power lines, to which the electric motor MG is connected at one end and the inverter 62 is connected at the other end. The busbars 68 are connected via the terminal block 82 to the MG busbars 84, which is connected to the first electric motor MG1 and the second electric motor MG2.

The inverter 62 converts DC current from the boost converter 60 into AC current for driving the first electric motor MG1 and the second electric motor MG2. The inverter 62 converts the AC current generated by the first electric motor MG1 using the power of the engine and the AC current generated by the second electric motor MG2 using regenerative braking, into the DC current. The inverter 62 supplies the AC current generated by first electric motor MG1 as drive power for the second electric motor MG2 depending on a running state of the vehicle. The first electric motor MG1 and the second electric motor MG2 are AC synchronous electric motors.

The electric vehicle further includes the electronic control apparatus 70 and a communication line 71. The electronic control apparatus 70 transmits and receives signals via the communication line 71 between the DC-DC converter 56 and the electric-motor control device 58, for example. The electronic control apparatus 70 performs various controls of the electric vehicle based on signals from, for example, sensors (not shown). The electric-motor control device 58 controls the boost converter 60 and the inverter 62 based on commands from the electronic control apparatus 70, and controls the first electric motor MG1 and the second electric motor MG2.

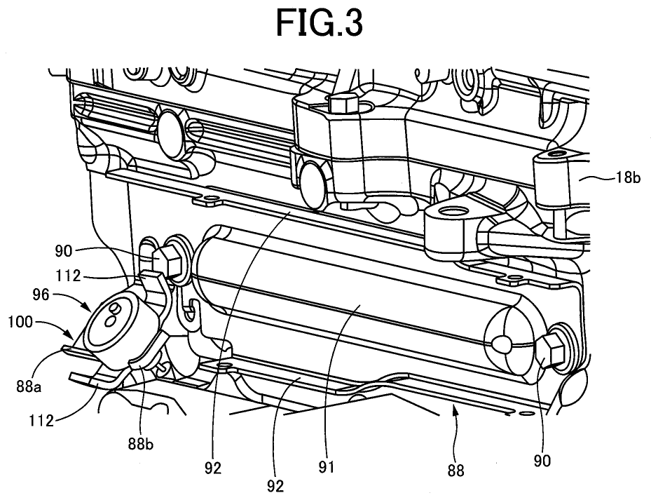

As shown in FIG. 3, an elongated, plate-shaped high-voltage protection member (hereinafter referred to as “service cover”) 88 that covers a service hole 86 is attached to a side surface of the casing body 18b through two bolts 90. The service cover 88 corresponds to “protection member” recited in the appended claims. The service cover 88 has an elongated, convex portion 91, elongated, reinforcing portions 92 and bolt-holes 94. The convex portion 91 is bent such that a central portion corresponding to the service hole 86 bulges outwardly. The reinforcing portions 92 are widthwise opposite end portions of the service cover 88 that are bent outwardly. The bolt-holes 94 are provided in longitudinally opposite end portions of the service cover 88.

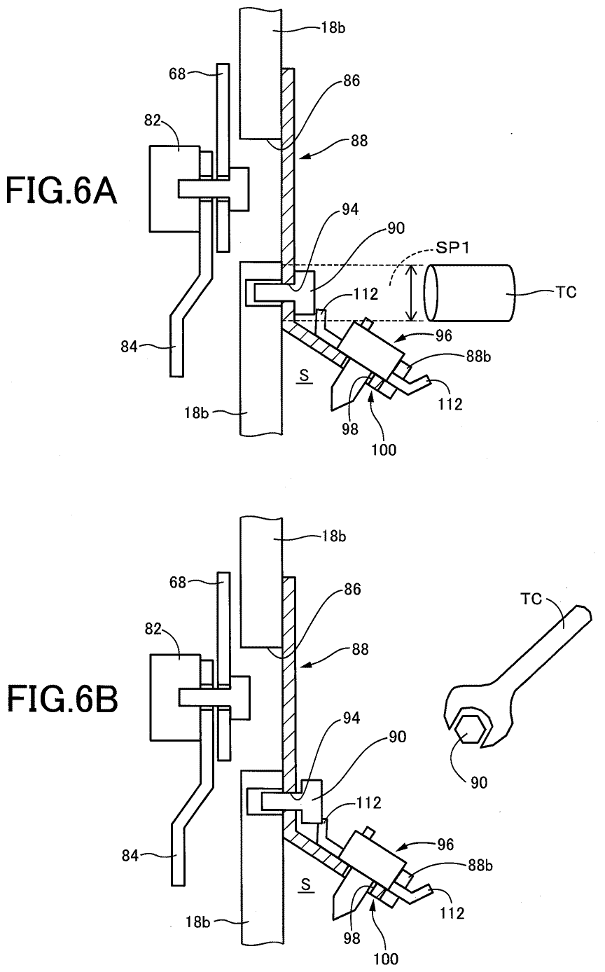

Furthermore, the service cover 88 is provided, at one of the longitudinally opposite end portions, with an inclined plate portion 100 in which a lock hole 98 (see FIG. 6) is formed for attaching a locking unit (hereinafter referred to as a “lock striker”) 96. The inclined plate portion 100 is inclined such that a shaft portion 108 of the lock striker 96 is separated from the side surface of the casing body 18b to form a gap S. That is, the inclined plate portion 100 of the service cover 88 and the casing 18 cooperate with each other to define the gap S therebetween. The bolt 90 and the lock striker 96 cooperate with each other to constitute an attaching device according to the present embodiment. The attaching device cooperates with the service cover 88 as the protection member to constitute “combination” recited in the appended claims.

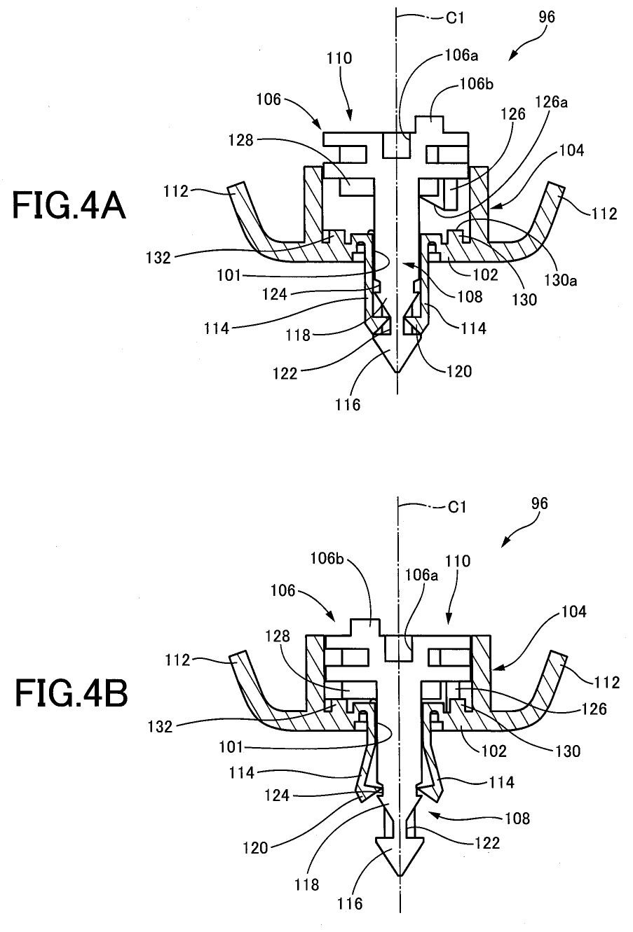

FIGS. 4A and 4B are cross-sectional views showing the lock striker 96, wherein FIG. 4A shows an unlocked state in which the lock striker 96 can be inserted into or removed from the lock hole 98, and FIG. 4B shows a locked state in which the lock striker 96 is fixed in the lock hole 98. A central engaging hole 106a and an engaging protrusion 106b are formed on an end surface of the disc-shaped portion 106 of the lock striker 96. The lock striker 96 can be removed from the lock hole 98 by using a special tool (lock-striker release key) ST, utilizing the central engaging hole 106a and the engaging protrusion 106b.

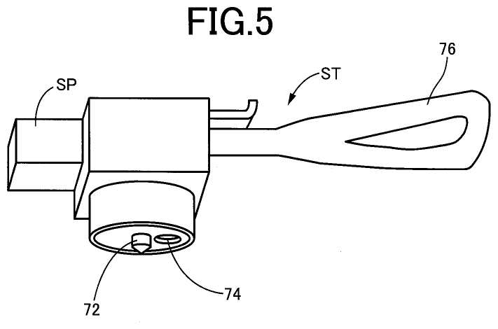

FIG. 5 shows the special tool ST integrated with a service plug SP. In addition to the service plug SP, the special tool ST is provided with an operating lever 76, and an engaging protrusion 72 and an engaging hole 74 that are to be engaged with the central engaging hole 106a and the engaging protrusion 106b of the lock striker 96, respectively. When a servicing operation is performed by removing the service cover 88 to access the high-voltage components in the service hole 86, the service plug SP is removed from a connector of the high-voltage battery 50, and the high-voltage components such as the busbars 68, terminal block 82 and MG busbars 84 are disconnected from the high voltage. Next, the engaging protrusion 72 and the engaging hole 74 of the special tool ST integrated with the service plug SP are engaged with the central engaging hole 106a and engaging protrusion 106b of the lock striker 96, and the operating lever 76 is rotated around the central engaging hole 106a, whereby an operation member 110 of the lock striker 96 is rotated relative to a main body of the lock striker 96, such that the locked state shown in FIG. 4B is switched to the unlocked state shown in FIG. 4A, whereby the lock striker 96 can be removed. It is noted that the main body of the lock striker 96 is constituted by a cup-shaped cylindrical portion 104, a pair of outwardly protruding portions 112 and a plurality of insert portions 114 (see FIGS. 4A and 4B).

As shown in FIGS. 4A and 4B, the pair of outwardly protruding portions 112 protrude symmetrically outwardly from the cup-shaped cylindrical portion 104, and each of the plurality of insert portions 114 has an inwardly protruding portion 120 and protrudes outwardly from an opening end of a center hole 101 of a bottom wall 102 of the cup-shaped cylindrical portion 104 in an axial direction of the center hole 101 that corresponds to a direction of an axis C1. The operation member 110 has a disc-shaped portion 106 that is to be engaged in an inner circumferential surface of the cup-shaped cylindrical portion 104, and a shaft portion 108 that extends from a center of the disc-shaped portion 106 and passes through the center hole 101 of the bottom wall 102 of the cup-shaped cylindrical portion 104 so as to protrude from the opening end of the center hole 101 further than the inwardly protruding portion 120 of each of the insert portions 114. The main body (constituted by the cup-shaped cylindrical portion 104, the outwardly protruding portions 112 and the insert portions 114) and the operation member 110 are molded from synthetic resin. The insert portions 114 surround the shaft portion 108, and cooperate with each other to form a cylindrical shape as a whole.

A first tapered portion 116 and a second tapered portion 118 are formed on an outer circumferential surface of the shaft portion 108 of the operation member 110 in this order from a distal end of the shaft portion 108. A first annular-groove portion 122 is formed between the first tapered portion 116 and the second tapered portion 118, into which the inwardly protruding portion 120 of each of the insert portions 114 is to be engaged. In addition, a second annular-groove portion 124, which is shallower than the first annular-groove portion 122, is formed in the shaft portion 108 adjacent to the second tapered portion 118 on a side of the disc-shaped portion 106.

An operation-member-side cam protrusion 126 and an operation-member-side stopper 128 are provided to protrude from a back surface of the disc-shaped portion 106 of the operation member 110. Also, a main-body-side cam protrusion 130 and a main-body-side stopper 132 are provided to protrude from the bottom wall 102 of the cup-shaped cylindrical portion 104 toward the disc-shaped portion 106 of the operation member 110. When the disc-shaped portion 106 of the operation member 110 is pushed into the cup-shaped cylindrical portion 104 of the main body, the operation-member-side stopper 128 and the main-body-side stopper 132 come into contact with each other, and the disc-shaped portion 106 is positioned in a lock position that is distant from an upper end of the opening of the center hole 101 of the bottom wall 102 of the cup-shaped cylindrical portion 104 by a predetermined distance, for example, 0.1 mm. In this state, the plurality of insert portions 114 are inserted into the lock hole 98, and a diameter defined by the insert portions 114 is expanded by the second tapered portion 118, whereby the lock striker 96 is fixed in the lock hole 98. FIG. 4B shows this state.

The operation-member-side cam protrusion 126 and the main-body-side cam protrusion 130 are equipped with an inclined cam surface 126a and an inclined cam surface 130a, respectively. When the disc-shaped portion 106 is rotated around the axis C1 by using the special tool ST shown in FIG. 5, the inclined cam surface 126a of the operation-member-side cam protrusion 126 and the inclined cam surface 130a of the main-body-side cam protrusion 130 come into sliding contact with each other, causing the disc-shaped portion 106 of the operation member 110 to protrude from the upper end opening of the cup-shaped cylindrical portion 104, and at the same time, the diameter define by the plurality of insert portions 114 is reduced within the lock hole 98, allowing the lock striker 96 to be removed from the lock hole 98. FIG. 4A shows this state.

As a result, when the operation member 110 is inserted into the lock hole 98 formed in the inclined plate portion 100 of the service cover 88 and is pushed into the cup-shaped cylindrical portion 104 to reach the lock position, the disc-shaped portion 106 of the operation member 110 is received in the cup-shaped cylindrical portion 104, and at the same time, the second tapered portion 118 causes the diameter defined by the plurality of insert portions 114 to be expanded within the lock hole 98, thereby fixing the lock striker 96 to the lock hole 98. However, when the operation member 110 is rotated around the axis C1 of the cup-shaped cylindrical portion 104 using the special tool ST, the operation-member-side cam protrusion 126 and the main-body-side cam protrusion 130 come into sliding contact with each other, and when the operation member 110 is returned from the lock position, the inwardly protruding portion 120 of each of the insert portions 114 is returned into the first annular-groove portion 122 and the diameter defined by the plurality of insert portions 114 is reduced, so that the lock striker 96 is allowed to be removed from the lock hole 98.

FIGS. 6A and 6B show a state in which the lock striker 96 is fixed in the lock hole 98 formed in the inclined plate portion 100 of the service cover 88. The service cover 88 includes a pair of engaging portions 88a, 88b that are provided in end portions of the inclined plate portion 100. The engaging portions 88a, 88b are bent so as to be engaged with the outwardly protruding portions 112 of the lock striker 96 fixed in the lock hole 98, thereby preventing the lock striker 96 from being rotated. The lock hole 98 of the service cover 88 is located in a position relative to the bolt 90 such that at least one of the cup-shaped cylindrical portion 104 and the outwardly protruding portion 112 of the main body of the lock striker 96 interferes with an ordinary holding/turning tool TC that is to be used for holding and turning the bolt 90. Thus, it is possible to prevent any operation that is to be performed by the ordinary holding/turning tool TC.

In FIG. 6A, a cylindrical socket wrench is shown as an example of the ordinary holding/turning tool TC, and the lock hole 98 is located in the position relative to the bolt 90 such that at least one of the cup-shaped cylindrical portion 104 and the outwardly protruding portions 112 of the main body of the lock striker 96 interferes with a space region SP1 that is indicated by dashed lines of the socket wrench that is to be engaged with a head of the bolt 90. In FIG. 6B, a standard wrench is shown as another example of the ordinary holding/turning tool TC, and the lock hole 98 is located in the position relative to the bolt 90 such that the outwardly protruding portions 112 of the main body of the lock striker 96 enters a rotation space region of the head of the bolt 90, or a space region of a rotation operation of the standard wrench that is to be engaged with the head of the bolt 90. The same applies in a case in which a glasses wrench is used instead of the standard wrench.

As described above, the attaching device according to the present embodiment of the invention includes: the bolt 90 configured to attach the service cover 88 onto the side surface of the casing body 18b; and the lock striker 96 configured to lock the bolt 90, by being introduced in the lock hole 98 of the service cover 88, such that the lock striker 96 is unremovable from the lock hole 98 except by the special tool ST, wherein the lock striker 96 is located in the position relative to the bolt 90 such that at least a part of the lock striker 96 interferes with the ordinary holding/turning tool TC that is to be used for holding and turning the bolt 90. Therefore, the ordinary holding/turning tool TC that attempts to hold and turn the bolt 90 interferes with the lock striker 96, which is fixed in the lock hole 98 of the service cover 88 such that the lock striker 96 cannot be rotated about the axis C1 by a predetermined angle or more, whereby an operation for removing the bolt 90 by the ordinary holding/turning tool TC is inhibited, namely, the service cover 88 cannot be removed by using the ordinary holding/turning tool TC. Further, protection from the high-voltage components can be achieved by using a simple structure in which the lock striker 96 is fixed to the service cover 88.

Further, in the present embodiment of the invention, the lock striker 96 includes: the main body including: the cup-shaped cylindrical portion 104; the outwardly protruding portions 112 that protrude outwardly from the cup-shaped cylindrical portion 104; and the insert portions 114 each of which has the inwardly protruding portion 120 and protrudes outwardly from the opening end of the center hole 101 of the bottom wall 102 of the cup-shaped cylindrical portion 104 in the axial direction of the center hole 101; and the operation member 110 including: the disc-shaped portion 106 that is to be engaged in the inner circumferential surface of the cup-shaped cylindrical portion 104; and the shaft portion 108 that extends from the center of the disc-shaped portion 106 and passes through the center hole 101 of the bottom wall 102 of the cup-shaped cylindrical portion 104 so as to protrude from the opening end of the center hole 101 further than the inwardly protruding portion 120 of each of the insert portions 114. The shaft portion 108 has the first tapered portion 116, the second tapered portion 118 and the first annular groove portion 122 that is provided between the first and second tapered portions 116, 118 in the axial direction of the shaft portion 108, such that the inwardly protruding portion 120 of each of the insert portions 114 is to be engaged in the first annular groove portion 122 of the shaft portion 108. The operation member 110 has the operation-member-side cam protrusion 126 provided in the disc-shaped portion 106, while the main body has the main-body-side cam protrusion 130 provided in the bottom wall 102, such that the operation-member-side cam protrusion 126 and the main-body-side cam protrusion 130 are opposed to each other, so as to come into contact with each other. Thus, when the operation member 110 is pushed into the main body and placed in the lock position, with the operation member 110 being inserted in the lock hole 98, the disc-shaped portion 106 of the operation member 110 is received in the cup-shaped cylindrical portion 104 of the main body, and at the same time, the second tapered portion 118 causes a diameter defined by the plurality of insert portions 114 to be expanded within the lock hole 98, thereby fixing the lock striker 96 to the lock hole 98. However, when the operation member 110 is rotated around the axis of the cup-shaped cylindrical portion 104 by using the special tool ST, the operation-member-side cam protrusion 126 and the main-body-side cam protrusion 130 come into sliding contact with each other, and when the operation member 110 is returned from the lock position, the inwardly protruding portion 120 of each of the insert portions 114 is returned into the first annular-groove portion 122 and the diameter defined by the plurality of insert portions 114 is reduced, so that the lock striker 96 is allowed to be removed from the lock hole 98.

Further, in the present embodiment of the invention, the lock hole 98 of the service cover 88, in which the lock striker 96 is introduced to lock the bolt 90, is located in the position relative to the bolt 90 such that at least one of the cup-shaped cylindrical portion 104 and the outwardly protruding portions 112 of the main body of the lock striker 96 interferes with the ordinary holding/turning tool that is to be used for holding and turning the bolt 90. Thus, the service cover 88 cannot be removed by using the ordinary holding/turning tool TC.

Further, in the present embodiment of the invention, the service cover 88 includes the engaging portions 88a, 88b that are engaged with the outwardly protruding portions 112 of the main body of the lock striker 96. Thus, even if the lock striker 96 fixed in the lock hole 98 is attempted to be rotated around the axis C1 of the main body, the engaging portions 88a, 88b of the service cover 88 interferes with the outwardly protruding portions 112 of the main body of the lock striker 96, thereby preventing the lock striker 96 from being rotated around the axis C1.

Further, in the present embodiment of the invention, the engaging portions 88a, 88b of the service cover 88 are provided in the inclined plate portion 100 of the service cover 88, and the inclined plate portion 100 of the service cover 88 and the casing 18 cooperate with each other to define the gap S (see FIGS. 6A and 6B) between the service cover 88 and the side surface of the casing body 18b. Thus, it is possible to eliminate a need to form holes through the casing body 18b for inserting the plurality of insert portions 114 and the shaft portion 108 of the lock striker 96, thereby eliminating restrictions on installation locations, and allowing a size of the casing 18 to be smaller than where the holes are formed through the casing 18.

Further, in the present embodiment of the invention, the special tool ST is provided with the detachable service plug SP arranged between the electric-power control unit 54 and the high-voltage battery 50. Thus, when the service plug SP is removed from the special tool ST prior to the servicing operation in which the special tool ST is engaged with the disc-shaped portion 106 of the operation member 110 to perform a rotational operation, the electric-power control unit 54 and the electric motor MG are disconnected from the high-voltage battery 50.

Although the embodiment of the present invention has been described in detail above with reference to the drawings, the present invention can also be applied to other embodiments.

For example, in the above-described embodiment, the lock striker 96 shown in FIGS. 3-6 is used as the locking unit to fix the service cover 88 to the lock hole 98, but other configurations may be used. In short, any device having a structure that allows the service cover 88 to be removed from the lock hole 98 only with the special tool ST can constitute the attaching device according to the invention.

In addition, in the above-described embodiment, the service cover 88 is formed as a horizontally elongated plate, but it may have other shapes.

When the drive unit 10 is installed in the electric vehicle, the respective positions of the first axis CL1, second axis CL2, third axis CL3 and fourth axis CL4 may be in the order of the first electric motor MG1, counter shaft 30, differential gear device 34 and second electric motor MG2, as seen from rear to front in the longitudinal direction. Also, the first electric motor MG1, second electric motor MG2 and electric-power control unit 54 may be housed in respective different casings. Also, the electric-power control unit 54 does not necessarily have to be located vertically above casing 18. Also, while the first electric motor MG1, second electric motor MG2 and electric-power control unit 54 are housed in respective spaces separated by partition walls within the casing 18 in the above-described embodiment, they may also be housed in the same space without being separated by partition walls.

Furthermore, in the above-described embodiment, the electric vehicle may be an electric vehicle equipped with a driving electric motor MG. This electric vehicle is different from the electric vehicle in the above-described embodiment mainly in that it does not have components around the first axis CL1 (engine, transmission including first electric motor MG1). In addition, in this electric vehicle, the first electric motor MG1 is eliminated, and the second electric motor MG2 functions as a driving electric motor MG for driving the electric vehicle. Alternatively, the electric vehicle may be a series hybrid vehicle equipped with an engine, a driving electric motor MG that functions as a power source and another electric motor MG that functions as an electric power generator that generates an electric power by using the power supplied from the engine that is connected to the other electric motor MG in a power transmittable manner. In such a series hybrid vehicle, a power transmission path between the engine and the drive wheels may be interrupted or connected by operation of a clutch. Alternatively, the electric vehicle may be an electric car equipped with an engine and a transmission that receives the power from the engine and supplies the power to the drive wheels. The electric vehicle may also be a parallel hybrid electric vehicle equipped with a power transmission device that transmits the power to the drive wheels and an electric motor MG that transmits the power to the drive wheels via the power transmission device.

It should be noted that the above is merely one embodiment, and the present invention can be practiced in various forms with various modifications and improvements based on the knowledge of those skilled in the art.

### NOMENCLATURE OF ELEMENTS

18: casing
54: electric-power control unit
86: service hole
88: service cover (protection member)
88a, 88b: engaging portion
90: bolt (attaching device)
96: lock striker (locking unit, attaching device)
98: lock hole
100: inclined plate portion
101: center hole
102: bottom wall
104: cup-shaped cylindrical portion (main body)
106: disc-shaped portion
108: shaft portion
110: operation member
112: outwardly protruding portion (main body)
114: insert portion (main body)
116: first tapered portion
118: second tapered portion
120: inwardly protruding portion
122: first annular-groove portion (annular groove portion)
126: operation-member-side cam protrusion
130: main-body-side cam protrusion
C1: axis
MG1: first electric motor (electric motor)
MG2: second electric motor (electric motor)
S: gap
ST: special tool
TC: holding/turning tool

What is claimed is:

1. An attaching device for attaching a protection member that is to be disposed to cover a service hole of a casing housing at least one of an electric-power control device and an electric motor of a vehicle,
the attaching device comprising:
a bolt configured to attach the protection member to the casing; and
a locking unit configured to lock the bolt, by being introduced in a lock hole of the protection member,
wherein the locking unit is located in a position relative to the bolt such that at least a part of the locking unit interferes with a holding/turning tool that is to be used for holding and turning the bolt.

2. The attaching device according to claim 1,
wherein the locking unit includes:
a main body including: a cup-shaped cylindrical portion; an outwardly protruding portion that protrudes outwardly from the cup-shaped cylindrical portion; and a plurality of insert portions each of which has an inwardly protruding portion and protrudes outwardly from an opening end of a center hole of a bottom wall of the cup-shaped cylindrical portion in an axial direction of the center hole; and
an operation member including: a disc-shaped portion that is to be engaged in an inner circumferential surface of the cup-shaped cylindrical portion; and a shaft portion that extends from a center of the disc-shaped portion and passes through the center hole of the bottom wall of the cup-shaped cylindrical portion so as to protrude from the opening end of the center hole further than the inwardly protruding portion of each of the insert portions,
wherein the shaft portion has a first tapered portion, a second tapered portion and an annular groove portion that is provided between the first and second tapered portions in an axial direction of the shaft portion, such that the inwardly protruding portion of each of the insert portions is to be engaged in the annular groove portion of the shaft portion, and
wherein the operation member has an operation-member-side cam protrusion provided in the disc-shaped portion, while the main body has a main-body-side cam protrusion provided in the bottom wall, such that the operation-member-side cam protrusion and the main-body-side cam protrusion are opposed to each other, so as to come into contact with each other.

3. A combination comprising:
a protection member that is to be disposed to cover a service hole of a casing housing at least one of an electric-power control device and an electric motor of a vehicle; and
the attaching device according to claim 2,
wherein a lock hole of the protection member, in which the locking unit is introduced to lock the bolt, is located in a position relative to the bolt such that at least one of the cup-shaped cylindrical portion and the outwardly protruding portion of the main body of the locking unit interferes with a holding/turning tool that is to be used for holding and turning the bolt.

4. A combination comprising:
a protection member that is to be disposed to cover a service hole of a casing housing at least one of an electric-power control device and an electric motor of a vehicle; and
the attaching device according to claim 2,
wherein the protection member includes an engaging portion that is engaged with the outwardly protruding portion of the main body of the locking unit.

5. The combination according to claim 4,
wherein the engaging portion of the protection member is provided in an inclined plate portion of the protection member, and
wherein the inclined plate portion of the protection member and the casing cooperate with each other to define a gap therebetween.

6. The attaching device according to claim 1,
wherein, when being introduced in the lock hole of the protection member, the locking unit is unremovable from the lock hole except by a special tool.
